(19) United States
(12) Patent Application Publication
(10) Pub. No.: US 2023/0315605 A1
(43) Pub. Date: Oct. 5, 2023

(54) USER SESSION IDENTIFICATION BASED ON TELEMETRY DATA

(71) Applicant: Dell Products L.P., Round Rock, TX (US)

(72) Inventors: Jake Mitchell Leland, Round Rock, TX (US); Tyler Ryan Cox, Austin, TX (US); Ryan Nicholas Comer, Round Rock, TX (US); Marc Randall Hammons, Round Rock, TX (US)

(73) Assignee: Dell Products L.P., Round Rock, TX (US)

(21) Appl. No.: 17/657,484

(22) Filed: Mar. 31, 2022

(51) Int. Cl. G06F 11/34; G06F 9/54; G06K 9/62

(52) U.S. Cl. CPC G06F 11/3438; G06F 9/542; G06K 9/628

(57) ABSTRACT

This disclosure provides systems, methods, and apparatuses for a user interaction recognition. In an aspect, a method includes receiving, at a server, first telemetry information from a first device, the first telemetry information associated with a first user session of a first application, the first user session associated with a first user. The method further includes receiving second telemetry information from a second device, the second telemetry information associated with a second user session of a second application, the second user session associated with a second user. The method also includes generating an interaction candidate based on a comparison of the first telemetry information and the second telemetry information, and transmitting the interaction candidate to the first device.

### FIELD OF THE DISCLOSURE

The instant disclosure relates to information handling systems. More specifically, portions of this disclosure relate to recognition of a user interaction associated with a user session.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be used in conjunction with one or more applications, such as one or more user experience applications. A user experience application may include or correspond to a user experience, such as a gaming experience, a metaverse experience, a streaming service experience, a video call experience, or other type of experience, as illustrative, non-limiting examples. As an example, an information handling system may be used with or as part of a gaming experience in which information of a gaming session associated with a user is received, generated, stored, or processed by the information handling system.

### SUMMARY

As user experience applications, and user experiences associated with the user experience applications, become more social, a user having a user session may interact with one or more other users during the user session. To illustrate, the user session may be a gaming session in which the user plays a multiplayer game via online multiplayer interfaces. During the user session in which the user interacts with the one or more other users, the information handling system may receive information associated with the user session of the user. Information provided about another user varies between user experience applications (e.g., games). Some information that is available or able to be determined for or about another user during the user session of the user include a name or user ID of the other user, an online status of the other user, a user experience application being consumed by the other user. Additional telemetry data may be used to improve identification of correlation between two users executing applications on different user devices. The identification of correlated user sessions and behaviors may be used to improve user experiences. For example, embodiments of this disclosure may infer teammates that a user is playing with or against based on telemetry information. The telemetry information can be assigned different levels of confidence based on a classification of the telemetry information. An application may specifically provide telemetry information or the telemetry information may be captured by an information handling system during execution of the application. The telemetry information may include a mix of available telemetry and session history and be used to intelligently identify a user's teammates during a gaming session. When a user is engaged in a gaming session with other players, parallels in the telemetry may be identified based on analyzing the data and/or comparing with models. In some embodiments, an information handling system may use time-series telemetry to recognize trends in gameplay and identify likely teammates. The models may incorporate feedback to improve the model and over time learn the behavior of the user to build confidence in teammate identification.

According to one configuration of the present disclosure, the present disclosure includes a method including receiving first telemetry information from a first device, the first telemetry information associated with a first user session of a first application, the first user session associated with a first user. The method also includes receiving second telemetry information from a second device, the second telemetry information associated with a second user session of a second application, the second user session associated with a second user. The method further includes generating an interaction candidate based on a comparison of the first telemetry information and the second telemetry information, and transmitting the interaction candidate to the first device.

Some configurations of the method of the present disclosure can include, after transmitting the interaction candidate, receiving, from the first device, an interaction type determined based on the interaction candidate. The method may also include storing an indication of the interaction candidate, the interaction type, or both, in association with first user session information associated with the first user session. In some implementations, the first application and the second application are the same application.

Some configurations of the method of the present disclosure can include receiving, based on the first telemetry information, session information associated with one or more user sessions that occurred prior to the first user session, the one or more user sessions associated with the first user. In some implementations, the interaction candidate is further generated based on at least one user session of the one or more user sessions.

Some configurations of the method of the present disclosure can include determining, based on the first telemetry information, an interaction event, and determining a classification associated with the interaction event, the classification selected from multiple classifications. The method may also include determining a value associated with the interaction event. In some implementations, the interaction candidate is further generated based on one or more interaction events including the interaction event.

Some configurations of the method of the present disclosure can include accessing a model associated with the first user, the second user, or a combination thereof. The method may further include determining the weight value associated with the interaction event based on the model. In some implementations, the weight value is a static value that corresponds to the classification. In some other implementations, the method may include receiving session information associated with one or more user sessions that occurred prior to the first user session, the one or more user sessions associated with the first user, and updating a prior model associated with the first user, the second user, or a combination thereof, based on the session information, to generate the model.

Some configurations of the method of the present disclosure can include initiating at prompt at the first user device, the prompt requesting input whether the first user interacted with the second user during the first use session. The method may also include receiving a response to the prompt from the first user device.

Some configurations of the method of the present disclosure can include receiving session information associated with one or more user sessions associated with the first user, wherein each of the one or more user sessions includes a determined interaction between the first user and the second user during the user session. The method may also include generating an output based on at least one interaction between the first user and the second user indicated by the one or more user sessions, and transmitting the output to the first user device.

According to another configuration of the present disclosure, the present disclosure includes a system. The system includes a first device associated with a first user session of a first application, the first user session associated with a first user, the first user device configured to generate first telemetry information associated with the first user session. The system also includes a second device associated with a second user session of a second application, the second user session associated with a second user, the second user device configured to generate first telemetry information associated with the first user session. The system further includes a server configured to receive the first telemetry information from the first device and receive the second telemetry information from the second device. The server is further configured to generate an interaction candidate based on a comparison of the first telemetry information and the second telemetry information and transmit the interaction candidate to the first device.

Some configurations of the system of the present disclosure, the server is further configured to, after transmitting the interaction candidate, receiving, from the first device, an interaction type determined based on the interaction candidate. The server may also be configured to store an indication of the interaction candidate, the interaction type, or both, in association with first user session information associated with the first user session. In some implementations, the first application and the second application are the same application.

Some configurations of the system of the present disclosure, the server is further configured to receive, based on the first telemetry information, session information associated with one or more user sessions that occurred prior to the first user session, the one or more user sessions associated with the first user. In some implementations, the interaction candidate is further generated based on at least one user session of the one or more user sessions.

Some configurations of the system of the present disclosure, the server is further configured to determine, based on the first telemetry information, an interaction event, and determine a classification associated with the interaction event, the classification selected from multiple classifications. The server may also be configured to determine a value associated with the interaction event. In some implementations, the interaction candidate is further generated based on one or more interaction events including the interaction event.

Some configurations of the system of the present disclosure, the server is further configured to access a model associated with the first user, the second user, or a combination thereof. The server may also be configured to determine the weight value associated with the interaction event based on the model. In some implementations, the weight value is a static value that corresponds to the classification. In some other implementations, the server may also be configured to receive session information associated with one or more user sessions that occurred prior to the first user session, the one or more user sessions associated with the first user; and update a prior model associated with the first user, the second user, or a combination thereof, based on the session information, to generate the model.

Some configurations of the system of the present disclosure, the first device is further configured to generate at prompt at the first user device, the prompt requesting input whether the first user interacted with the second user during the first use session. The first device may also be configured to determine whether response to the prompt is received, and determine, based on whether the response is received, an interaction type associated with the interaction candidate. The first device can also be configured to transmit an indication of the interaction type to the server.

According to another configuration of the present disclosure, the present disclosure includes an apparatus, such as a user device. The apparatus includes at least one processor and a memory coupled with the at least one processor and storing processor-readable code that, when executed by the at least one processor, is configured to perform operations. The operations include generating first telemetry information associated with a first user session of a first application, the first user session associated with a first user, and transmitting the first telemetry information to a server. The operations further include receiving, from the server, an interaction candidate, the interaction candidate associated with a potential interaction between the first user of the first user session and a second user of a second user session associated with a second application. The operations also include determining an interaction type determined based on the interaction candidate.

In some configurations of the apparatus of the present disclosure the operations can further include initiating transmission of the interaction type to the server.

In some configurations of the apparatus of the present disclosure, the operations can further include generating at prompt at the first user device, the prompt requesting input whether the first user interacted with the second user during the first use session. The operations may also include determining whether response to the prompt is received, and determining, based on whether the response is received, an interaction type associated with the interaction candidate. The operations can also include transmitting an indication of the interaction type to the server.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of the present disclosure in order that the detailed description that follows may be better understood. Additional features and advantages will be described hereinafter that form the subject of the claims of the disclosure. It should be appreciated by those having ordinary skill in the art that the conception and specific implementation disclosed may be readily utilized as a basis for modifying or designing other structures for carrying out the same or similar purposes. It should also be realized by those having ordinary skill in the art that such equivalent constructions do not depart from the spirit and scope of the disclosure as set forth in the appended claims. Additional features will be better understood from the following description when considered in connection with the accompanying figures. It is to be expressly understood, however, that each of the figures is provided for the purpose of illustration and description only and is not intended to limit the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating aspects of a configurable system for providing services to users according to one or more aspects of the present disclosure.

FIG. 2 is a block diagram illustrating possible application environments according to one or more aspects of the present disclosure.

FIG. 3A is a block diagram illustrating application and services hosted in different application environments according to one or more aspects of the present disclosure.

FIG. 3B is a block diagram illustrating application and services hosted in different application environments according to one or more aspects of the present disclosure.

FIG. 3C is a block diagram illustrating application and service hosted in a common application environment according to one or more aspects of the present disclosure.

FIG. 3D is a block diagram illustrating a cloud-based service arrangement for an application environment according to one or more aspects of the present disclosure.

FIG. 4 is a block diagram illustrating an example of a system for recognition of user interaction associated with a user session according to one or more aspects of the present disclosure.

FIG. 5 is a block diagram illustrating an example of a system for recognition of user interaction associated with a user session according to one or more aspects of the present disclosure.

FIG. 6 is a flow diagram of an example of a method of recognition of user interaction associated with a user session according to one or more aspects of the present disclosure.

FIG. 7 is a block diagram illustrating an example of a system for recognition of user interaction associated with a user session according to one or more aspects of the present disclosure.

FIG. 8 illustrates a diagram of an example of an interface according to one or more aspects of the present disclosure.

FIG. 9 illustrates a diagram of another example of an interface according to one or more aspects of the present disclosure.

FIG. 10 illustrates a flow diagram of an example of a method of recognition of user interaction associated with a user session according to one or more aspects of the present disclosure.

FIG. 11 is a schematic block diagram of an example information handling system according to some embodiments of the disclosure.

### DETAILED DESCRIPTION

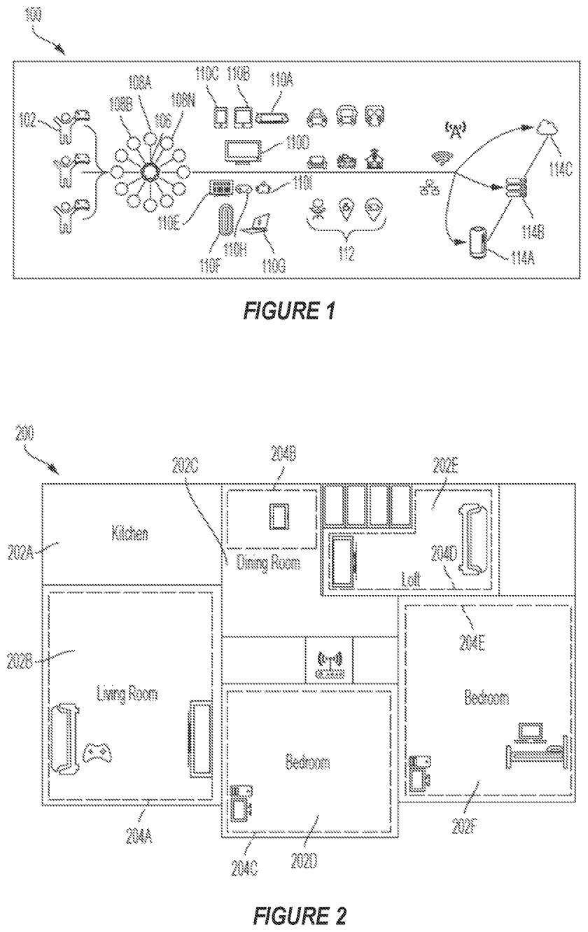

FIG. 1 is a block diagram illustrating aspects of a configurable system for providing services to users according one or more aspects of the present disclosure. A system 100 includes users 102 who may have access, such as via a user account, to a shared library of applications 106 including applications 108A-108N. Users 102 may have separate libraries, with some overlapping applications between the libraries. Users 102 may access the library 106 through devices 110A-I, such as a mobile gaming device 110A, a tablet computing device 110B, a phone computing device 110C, a television 110D, a personal computing device 110E, a desktop computing device 110F, a laptop computing device 110G, a game controller 110H, or a virtual reality (VR) headset 110I. Devices 110 may access services at any of locations 112, including cars, busses, homes, hotels, offices, parks, etc. One or more of devices 110 may communicate with an application session executing on a computing device 114, such as a home application hub 114A, a server 114B, or a cloud execution environment 114C. In some implementation, environments may only exist for fixed devices, e.g., desktop computers, televisions, etc.

In some implementations, an application session, such as a gaming session or a metaverse session, may execute on a service, either locally on a device, on another system on a network, or in the cloud. A device, such as one of devices 110A-I, may access the application session by executing an application that communicates with the service to receive and transmit user input to the service and provide feedback to the user from the service. It is noted that a portion (or entirety) of the application session that the device associated with a user is accessing the application session may be referred to as a user session that is associated with the user. The device may include its own audio/visual (AV) output for displaying a graphical user interface and/or a rendered display from the application session. Different environments at a location may include different AV systems, and the device may be automatically paired with an AV system and may be reconfigured to support interaction with an application session using the paired AV system.

FIG. 2 is a block diagram illustrating possible application environments according to one or more aspects of the present disclosure. For example, one or more applications environments may include a location (e.g., 112), such as a home 200. To further illustrate, home 200 may be included in system 100 and a user at home 200 may use a device (e.g., 110) to access an application session.

Home 200 is one example location (e.g., 112) that may have multiple environments, such as a living room, a dining room, a study, and/or a bedroom, each with different screen configurations, speaker configurations, and/or network availability. An application session (e.g., a user session) may be supported by an information handling system that receives and/or uses available telemetry information (e.g., telemetry data) from multiple sources. In some implementations, the information handling system may use the telemetry information to build a confidence-based knowledge graph of the user's gaming environments and determine a position of the user within that graph. A system with knowledge of devices in a user's gaming environment may build a knowledge graph by aggregating and comparing telemetry information. For example, network telemetry may reveal that devices are positioned relatively near each other, a mobile device may reveal an absolute location based on GPS data, and/or an infrared presence sensor may reveal that the user is sitting in front a device. An intelligent system may assemble these individual pieces of telemetry into a broader knowledge graph based on the absolute and/or relative locations of the user's devices, the location of the user in relation, and or characteristics of the devices. This knowledge graph may be updated in real time and/or based on changes in device telemetry.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Home 200 may include rooms 202A-F, and each of the rooms may have different information handling systems present, different AV equipment present, and/or different characteristics. For example, a living room 202B may include a large-size television, a bedroom 202D may include a personal computer, and a dining room 202C may include a tablet computing device. Application environments 204A-E in the home 200 may be defined based on spaces where a user is likely to execute an application session. Each application environment 204A-E may include numerous devices and gaming environments, devices that may or may not be capable of hosting games, and/or devices that may or may not be capable of receiving game output. In some implementations, system 100 may allow multiple users in the home 200 to simultaneously execute or participate in an application session, such as the same or different application sessions. In some implementations, multiple games may be hosted on a single device. Additionally, or alternatively, multiple games may target a single output device. In some implementations, controller, such as computing device 114, manages where games should be hosted, where game output should go, and how to best route peripheral I/O for one or more users.

A user may move between gaming environments 204A-E within the home 200 and continue an application session. For example, a user may take a device, such as a gaming controller, from environment 204A to environment 204C. The gaming controller may migrate and reconfigure for operation in environment 204C from a configuration for environment 204A. For example, the controller may transition from an application hosted on a TV in living room 202B to an application hosted on TV in loft 202E while remaining connected to a host service executing on a PC in bedroom 202D.

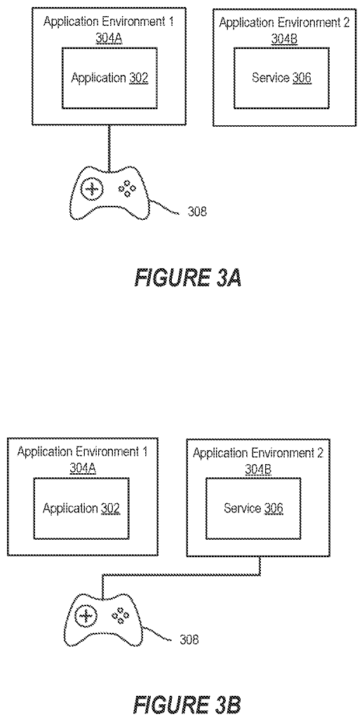

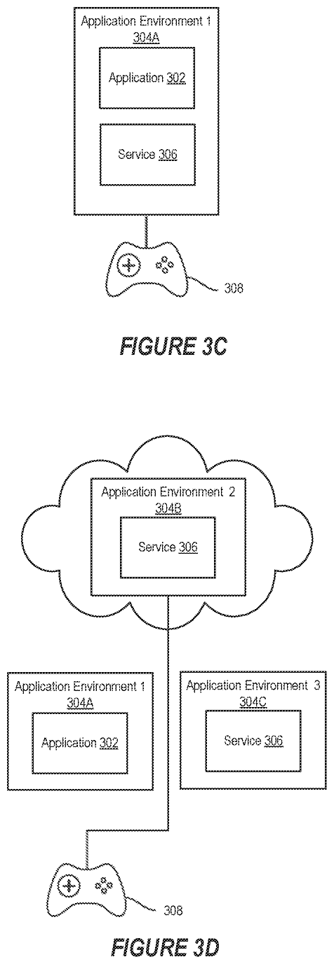

Example configurations for applications and services in application environments are shown in FIGS. 3A-3D. FIG. 3A is a block diagram illustrating application and services hosted in different application environments according to one or more aspects of the present disclosure. In some implementations, the different application environments may be included in system 100. For example, at least one application environment may be located in home 200. For example, an application environment described with reference to one or more of FIGS. 3A-D may include or correspond to application environment 204.

In FIG. 3A, a first application environment 304A may include a device (e.g., 112), such as a TV or PC, hosting an application 302, which is an endpoint for an application session such as a user session including a gaming session or a metaverse session, as illustrative, non-limiting examples. The application 302 communicates with a service 306, which may be hosted on a device in a different application environment 304B. A controller 308 may communicate with the application 302 to receive user input for the application session to control, for example, a character in a game or an avatar in a metaverse. In some implementations, controller 308 is connected to the environment 304A hosting the application and the I/O is configured to be relayed to the hosting environment 304B (e.g., the environment hosting the game or the metaverse).

FIG. 3B is a block diagram illustrating application and services hosted in different application environments according to one or more aspects of the present disclosure. In FIG. 3B, the controller 308 communicates with the service 306 for providing user input to an application session, with the AV rendering target of the application session being application 302 in a different gaming environment.

FIG. 3C is a block diagram illustrating application and service hosted in a common application environment according to one or more aspects of the present disclosure. In FIG. 3C, the application 302 and the service 306 are executed in the same gaming environment 304A, which may be a single device, two devices, or a combination of devices in the gaming environment 304A. The controller 308 may communicate with either the service 306 and/or the application 302.

FIG. 3D is a block diagram illustrating a cloud-based service arrangement for an application environment according to one or more aspects of the present disclosure. In FIG. 3D, the controller 308 may communicate with a service 306 hosted in a gaming environment 304B that is remote from the gaming environment 304A in which the application 302 is executing. The service 306 may be executing, for example, on a remote device, such as when the user's home includes the gaming environment 304B but the user is engaging with application 302 at a location on a different network from their home (e.g., at a friend's house). The service 306 may also or alternatively be executed, for example, on a cloud computing device available as a subscription service to the user.

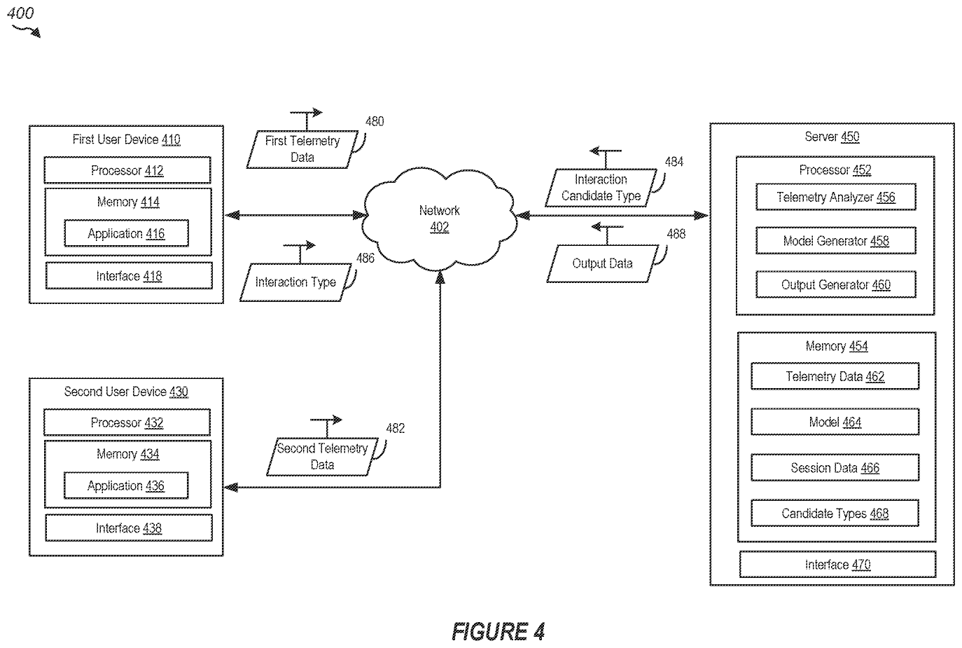

Referring to FIG. 4, FIG. 4 is a block diagram illustrating a system 400 for recognition of user interaction associated with a user session according to one or more aspects of the present disclosure. System 400 may include or correspond to system 100.

System 100 includes a network 402, a first user device 410, a second user device 430, and a server 450. Network 402 may include a wired network, a wireless network, or a combination thereof. To illustrate, network 402 may include a Bluetooth personal area network (PAN), a local area network (LAN), a wireless LAN (WLAN), a wide area network (WAN), a wireless network (e.g., a cellular network), a wired network, the Internet, one or more other networks, or a combination thereof, as illustrative, non-limiting examples.

First user device 410 and second user device 430 may include or correspond to one or more devices, such as device 110. To illustrate, first user device 410 or second user device 430 may include or correspond to a gaming console, a desktop computer, a laptop computer, a tablet, a mobile device, a peripheral device, a server (e.g., a cloud server), or another type of computing device, as illustrative examples. Additionally, or alternatively, first user device 410 or second user device 430 may include or correspond to an information handling system. In some implementations, first user device 410 or second user device 430 may be associated with an application environment, such as application environment 204, application environment 304, or a combination thereof.

First user device 410 may include one or more processors, such as a processor 412. Processor 412 may be a central processing unit (CPU) or other computing circuitry (e.g., a microcontroller, one or more application specific integrated circuits (ASICs), or the like) and may have one or more processing cores. First user device 410 may further include a memory 414 and an interface 418 (e.g., a wireless interface or a wired interface). Processor 412 may be coupled to memory 414, interface 418, or a combination thereof.

Memory 414 may include a read only memory (ROM) device, a random access memory (RAM) device, one or more hard disk drives (HDDs), a flash memory device, a solid state drives (SSDs), another devices configured to store data in a persistent or non-persistent state, or a combination of different memory devices. Memory 414 includes one or more instructions, such as an application 416. Application 416 may include or correspond to application 302. To illustrate, memory 414 may store instructions that, when executed by processor 412, cause processor 412 to perform operations as described herein. Additionally, memory 414 may store one or more thresholds, data, preferences, other settings, a combination thereof, or the like, as illustrative, non-limiting examples.

Interface 418 includes one or more communication interfaces. For example, interface 418 may include a long range (LoRa) interface, a Wi-Fi interface (e.g., an Institute of Electrical and Electronics Engineers (IEEE) 802.11 interface), a cellular interface (e.g., a fourth generation (4G) or long term evolution (LTE) interface, a fifth generation (5G) new radio (NR) interface, or the like), a Bluetooth interface, a Bluetooth low energy (BLE) interface, a Zigbee interface, a non-LoRa interface, another type of network interface, a combination thereof, or the like.

In some implementations, first user device 410 may include one or more additional devices or components. For example, first user device 410 may include an I/O device, such as one or more switches (e.g., depressible buttons, triggers, or the like), directional pads, one or more touchscreens, a microphone, a camera, one or more speakers, one or more light sources, vibration devices, other types of devices, or a combination thereof, as illustrative, non-limiting examples.

Second user device 430 may include or correspond to first user device 410. Second user device 430 may include one or more processors, such as a processor 432. Processor 432 may include or correspond to processor 412. Processor 432 may be a CPU or other computing circuitry (e.g., a microcontroller, one or more ASICs, or the like) and may have one or more processing cores. Second user device 430 may further include a memory 434 and an interface 438 (e.g., a wireless interface or a wired interface). Processor 432 may be coupled to memory 434, interface 438, or a combination thereof. Memory 434 and interface 438 may include or correspond to memory 414 and interface 418, respectively.

Memory 434 may include a ROM device, a RAM device, one or more HDDs, a flash memory device, an SSD, or other devices configured to store data in a persistent or non-persistent state, or a combination of different memory devices. Memory 434 includes one or more instructions, such as an application 436. Application may include or correspond to application 416. Memory 434 may store instructions that, when executed by processor 432, cause processor 432 to perform operations as described herein. Additionally, memory 434 may store one or more thresholds, data, preferences, other settings, a combination thereof, or the like, as illustrative, non-limiting examples.

Interface 438 includes one or more communication interfaces. For example, interface 438 may include a LoRa interface, a Wi-Fi interface (e.g., an IEEE 802.11 interface), a cellular interface (e.g., a 4G or LTE interface, a 5G NR interface, or the like), a Bluetooth interface, a BLE interface, a Zigbee interface, a non-LoRa interface, another type of network interface, a combination thereof, or the like.

In some implementations, second user device 430 may include one or more additional devices or components. For example, second user device 430 may include an I/O device, such as one or more switches (e.g., depressible buttons, triggers, or the like), directional pads, one or more touchscreens, a microphone, a camera, one or more speakers, one or more light sources, vibration devices, other types of devices, or a combination thereof, as illustrative, non-limiting examples.

In some implementations, a user device (e.g., 410 or 430) includes or is coupled to one or more peripheral devices. The one or more peripheral device may include or correspond to a game controller (e.g., a gamepad or a joystick controller), a mouse, a keyboard, a display, a speaker, a microphone, a headset, a virtual reality (VR) device, an augmented reality (AR) device, a vehicle control simulation device (such as a racing wheel or a vehicle pedal assembly), a musical instrument simulation device (such as a guitar controller), a detachable controller, or a brain-computer interface (BCI) device, as illustrative examples. In some implementations, a peripheral device of the one or more peripheral devices may correspond to a streaming device configured to stream content, such as gaming content or metaverse content, from the user device (e.g., 410 or 430). For example, the peripheral device may correspond to a handheld gaming device, a phone, a tablet, or a computer that streams gaming content from the user device (e.g., 410 or 430).

A peripheral device of the one or more peripheral device may include a processor, a memory, an interface, or a combination thereof. Additionally, or alternatively, the peripheral device may include one or both of an input device that receives user input (such as user operation of a button or other input device) or an output device that generates an output (such as one or more of an audio output, a visual output, a haptic output, or another output). To illustrate, the peripheral device may be configured to receive user input and to transmit signals to the user device (e.g., 410 or 430) based on the user input (e.g., via a wired or wireless connection to the user device). Additionally, or alternatively, the peripheral device may be configured to receive commands from the user device (e.g., 410 or 430) (e.g., via a wired or wireless connection to the user device) and to generate an output (such as one or more of an audio output, a visual output, a haptic output, or another output) based on the commands.

Server 450 may include or correspond to computing device 114. In some implementations, server 450 is configured to host an application session or provide a service. Additionally, or alternatively, server 450 may include or correspond to an information handling system. In some implementations, server 450 is configured as a cloud server or a cloud execution environment.

Server 450 may include one or more processors, such as a processor 452. Processor 452 may be a CPU or other computing circuitry (e.g., a microcontroller, one or more ASICs, or the like) and may have one or more processing cores. Server 450 may further include a memory 454 and an interface 470 (e.g., a wireless interface or a wired interface). Processor 452 may be coupled to memory 454, interface 470, or a combination thereof.

In some implementations, processor 452 may include or be configured as a telemetry analyzer 456, a model generator 458, an output generator 460, or a combination thereof. Although described as being included in processor 452, in other implementations, telemetry analyzer 456, model generator 458, output generator 460, or a combination thereof, may additionally or alternatively be included in processor 412 or processor 432.

Telemetry analyzer 456 may receive telemetry data from individual systems during or after execution of applications, including game applications. In some embodiments, the telemetry data may be aggregated and correlated in a cloud system. In some embodiments, the telemetry data may be aggregated and correlated in a local system, as the gaming hub in a user's home environment. The analyzer 456 may analyze the telemetry data to parse the telemetry information into separate sets of data and provide the parsed telemetry data and/or other representations of the telemetry information to the model generator 458. For example, telemetry information itself may indicate a teammate that you are playing with (or against) specifically provided by the application. As another example, the telemetry information may be parsed and analyzed, such as by comparing system information and timestamps, to determine a teammate that a user is playing with (or against). Regardless of how the simultaneous occurrence is determined, the information may be provided to model generator 458. A further example for analyzing telemetry data may include determining a game match result, in which a list includes two users together, such as a list of final standings of a match that included two names could indicate that the individuals were playing together. As yet another example for analyzing telemetry data, join mechanics may be analyzed, such as determining when a user clicks to join a game with friend, and/or whether a user invites another player to join a game.

These examples may provide some useful information regarding player history from the telemetry data. The indicated context may indicate that two players were playing the same game at the same time (same date and time), but not if they were playing on a team or individually at the same time. The analyzer 456 may apply thresholds to the telemetry data, such as whether the start and stop time are the same or are within a threshold time period of each other to determine corresponding game sessions between two users of an application. Other context information that may be determined by the telemetry analyzer 456 is whether two users unlock the same achievement at approximately the same time. The telemetry analyzer 456 may determine that more events that lineup based on the telemetry data provide a high confidence that two individuals are playing together, even if the application itself does not provide information that the two individuals are playing together.

The telemetry analyzer 356 may apply different confidence levels to certain correlated types of information between two sets of telemetry information. For example, events such as ecosystem friend groupings (that two friends are playing together), game match results (that a results list contains two users together), and/or join mechanics data (that a user clicks to invite or accept a game with another user) may be considered high-confidence events.

The telemetry analyzer 356 may also determine middle-confidence telemetry data for indicating an interaction candidate. Mid-Confidence Teammate Events may include, e.g., in-game presence (that two friends are playing the same level/mode of a game), in-game session start/stop times (that two friends are playing the level/mode at the same time), achievement unlocks (two friends unlocking achievement at same time), and/or location (shared user locations).

The telemetry analyzer 356 may also determine low-confidence telemetry data for indicating an interaction candidate. Low-Confidence Teammate Events may include, e.g., GPU usage (that two user's information handling systems had high GPU utilization during the same time frame, such as with correlated start and end times indicating a common gaming session or with correlated high memory utilization indicating correlated loading of a new level after the two users completed a previous level together or with correlated loading of the same assets indicating two users are playing the same level or same map), location, presence (that two friends are playing the same game), session start/stop times (that two friends are playing the game at the same time), session start/stop times (that two friends are playing the game at the same time), game metadata (that the game has multiplayer mechanic), statistics updates (e.g., win/loss) (that correlates two friends' statistics), memory access patterns (that indicated a correlation in system usage), network access patterns (that indicate a correlation in system usage, sockets, source), CPU access patterns (that indicate a correlation in system usage), GPU access patterns (that indicate a correlation in system usage), file access patterns (that indicated a correlation in system usage), social/chat context (that indicated friends communicating with each other about a game), and/or image recognition/OCR (that indicates other users/usernames on screen while one user is in a game application).

The telemetry analyzer 456 may generate interaction candidates based on the telemetry data, or a model generator 458 may be trained with the telemetry data to generate one or more models for identifying interaction candidates from the telemetry data. For example, a model may be updated by adjusting the weights assigned to different correlated events. When the model generator 458 executes on a user's home application hub, the model may be trained to recognize interaction candidates based on a particular user's behavior. For example, teammate data is built up and reinforces the relative strength of relationships between users. The model generator 458 may be used in combination with the telemetry analyzer 456 to determine an interaction candidate.

Interaction candidates and/or other information output from telemetry analyzer 456 and model generator 458 may be provided to output generator 460. The output generator 460 may produce output, such as through a graphical user interface (GUI) to a user, to indicate the correlated users and/or applications. For example, the output generator 460 may suggest teammates who you are more likely to play the same games. As another example, the output generator 460 may provide a rich session history for user timeline view and profile page indicating overlap of a user's games and other user's games, and may include statistics from those games, as part of a “journey together” between the users. As a further example, the output generator 460 may generate party highlights mixing recorded/captured content from multiple teammates. Further examples of output from output generator 460 may include communications orchestration, social/sharing prioritization, game recommendations, party identification, scheduled event coordination (cons, tournaments, social events, etc.), third-party offer coordination and prioritization, coordinated recommendations on streamers/influencers, coordinated recommendations on media and content (channels, news, music, etc.), competitive skill analysis and training recommendations, eSports recruiting and events, MMOG clan recruiting and events, targeted advertising, matchmaking and/or “pick-up”-style gameplay enablement, couch gaming intent recognition, relay-style gameplay (in which one game is handed off across teammates), peripheral rotation (offering the switching of characters during gameplay), game party treasure hunt mode, and/or intelligent push notifications to remote join the session.

Memory 454 may include a ROM device, a RAM device, one or more hard disk drives (HDDs), a flash memory device, an SSD, another device configured to store data in a persistent or non-persistent state, or a combination of different memory devices. Memory 454 includes one or more instructions, such as an application or a service. The application may include or correspond to application 416 or 436. The service may include or correspond to service 306. To illustrate, memory 454 may store instructions that, when executed by processor 452, cause processor 452 to perform operations as described herein.

Additionally, memory 454 may store one or more thresholds, data, preferences, other settings, a combination thereof, or the like, as illustrative, non-limiting examples. For example, memory 454 may include or be configured to store telemetry data 462, a model 464, session data 466, candidate types 468, or a combination thereof. Although memory 454, and server 450, are described as including each of telemetry data 462, model 464, session data 466, and candidate types 468, in other implementations, telemetry data 462, model 464, session data 466, candidate types 468, or a combination thereof, may be stored at a memory or database that is separate from and accessible to server 450.

Interface 470 includes one or more communication interfaces. For example, interface 470 may include a LoRa interface, a Wi-Fi interface (e.g., an IEEE 802.11 interface), a cellular interface (e.g., a 4G or LTE interface, a 5G NR interface, or the like), a Bluetooth interface, a BLE interface, a Zigbee interface, a non-LoRa interface, another type of network interface, a combination thereof, or the like.

During operation, system 400 may involve data transfer between the server 450, which may be the user application hub (such as a home gaming hub) or a cloud-based server, and one or more user devices 410 and 430. Operations performed by the system 400 may include training a user relationship model in model generator 458 based on telemetry information processed by telemetry analyzer 456 including ecosystem telemetry (e.g., application sessions, user information) and system telemetry (e.g., CPU utilization, GPU utilization, memory loads). The processor 452 may determine an occurrence of a first event for a first user in a first application and determine occurrence of a second event for a second user in a second application. The processor 452 may determine a relationship between the second user and the first user based on the first event, the second event, and the user relationship model. The processor 452 may update a session history for the first user to indicate the relationship between the first user and the second user. The processor 452 may then determine a recommendation, or other output from the output generator 460, for the first user based on the user relationship model.

In determining relationships, data of different kinds may be assigned different weights and a value reflecting the likelihood of a match between users assigned. The weights may be assigned based on a cloud repository of values or machine learning. A user specified input may be the highest value and treated as correct. If the ecosystem telemetry identifies the other person as playing in the game, that data may be assigned a weight of one. If the telemetry identifies a person is invited to join, that data may be assigned a weight of one. An example of classifications for telemetry data and assigned weights is shown in Table 1:

TABLE 1

| Classification | Description | Weight |
|---|---|---|
| User Label | User indicated | 1 |
| Cooperative | Ecosystem exposed gameplay grouping | 1 |
| Nexus Party | Users joined session from Nexus | 1 |
| Semi- | Grouping determined from rich presence | 0.3 |
| Cooperative | data | |
| Non-Cooperative | Grouping determined from non-ecosystem | 0.2 |
| | data | |
| Squad Goals | Grouping suggested by past history only | 0.1 |

The weightings of Table 1 may be associated with a model corresponding to users generally or the first user specifically. The model, and the weightings in the model, may be updated over time based on additional information received from the user or others users. For example, an interaction candidate may be transmitted to a user based on the weighting of Table 1. Subsequently, additional information, such as third telemetry data, may be received at a server in response to additional user activity at a client device. The server may update the model and/or weights based on the third telemetry data.

An example computation for a relationship value is shown in Table 2:

TABLE 2

| | | Cumulative |
|---|---|---|
| Classification | Description | Total |
| Non-Cooperative | User and Friend start game at same time | +0.2 |
| Event | | |
| “Squad Goals” | User and Friend have played together in | +0.1 |
| Event | past sessions | |
| “Semi- | User and Friend unlock achievement at | +0.3 |
| Cooperative” | same time | |
| Event | | |
| “Non- | User and Friend stop game at same time | +0.2 |
| Cooperative” | | |
| Event | | |
| Result | Friend classified as a “Semi- | =0.8 |
| | Cooperative” session Teammate, | |
| | likelihood | |

The weights in Table 2 may have been updated over time from the weights in Table 1 based on additional information. For example, Table 1 shows a weight of 0.1 assigned to grouping suggested by past history whereas Table 2 shows a weight of 0.2 for a user and friend starting and stopping a game together. In some embodiments, the update to the weight from 0.1 in Table 1 to 0.2 in Table 2 may be based on a server updating an interaction candidate model based on telemetry data received from the user's client device, the friend's client device, and/or other user's client devices. That is, the model may learn from user behavior which factors (and associated weights) are better indicators of user interaction.

Another example computation for a relationship value is shown in Table 3:

TABLE 3

| | Cumulative |
|---|---|
| Description | Total |
| User and Friend start game G at same time → No prior | +0.1 |
| history, use default weight | |
| User and Friend stop game G at same time → No prior | +0.1 |
| history, use default weight | |
| User at location L1, Friend at location L2 → No prior | +0.0 |
| history, use default weight | |
| Friend not classified as session Teammate, likelihood | =0.2 |
| User edits session history and manually marks Friend | =1.0 |
| as a teammate | |
| Update: Friend classified as session Teammate based | |
| on user input, likelihood | |

Another example computation for a relationship value is shown in Table 4:

TABLE 4

| | Cumulative |
|---|---|
| Description | Total |
| User and Friend start game G at same time → Some prior | +0.2 |
| history, use increased weight | |
| User and Friend stop game G at same time → Some prior | +0.2 |
| history, use increased weight | |
| User at location L1, Friend at location L2 → Some prior | +0.1 |
| history, use increased weight | |
| Friend not classified as session Teammate, likelihood | =0.5 |
| System prompts user, asking if Friend was a session | |
| Teammate → User confirms Teammate | |
| Update: Friend classified as session Teammate based on | =1.0 |
| user confirmation, likelihood | |

Another example computation for a relationship value is shown in Table 5. In this example, two people starting/joining a game session within a threshold time period of each other may be a more heavily weighted indicator than when the people stop or leave a game session.

TABLE 5

| | Cumulative |
|---|---|
| Description | Total |
| User and Friend start game G at same time → More prior | +0.3 |
| history, use increase weight | |
| User and Friend stop game G at same time → More prior | +0.3 |
| history, use increase weight | |
| User at location L1, Friend at location L2 → More prior | +0.2 |
| history, use increased weight | |
| Friend classified as session Teammate based on start/stop | =0.8 |
| and past sessions, likelihood | |

The processor 452 may execute algorithms to determine correlation between telemetry data for different users, such as a cloud learning operation. For example, the model generator 458 may determine that ending at the same time because a game is a session-based game may be a better indicator than a game that is freeform and allows users to jump in and out of the game. In another example, the model generator 458 may use user location to assist with identifying correlations. People playing in the same room at the same time is a better indicator of being in the same gaming session, such that location is a piece of telemetry data that can increase confidence. The weights for determining correlations may dynamically adjusted based on a history.

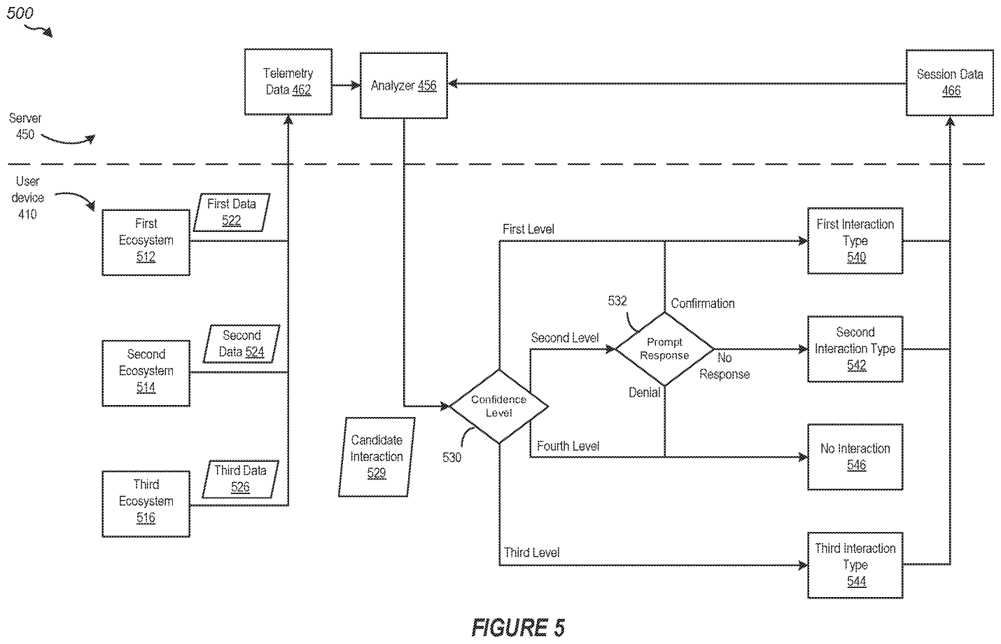

FIG. 5 an example of a system 500 for recognition of user interaction associated with a user session according to one or more aspects of the present disclosure. System 500 may include or correspond to system 100 or 400.

System 400 includes user device 410 and a server 450. User device 410 and server 450 may be coupled via a network, such as network 402. User device 410 may include one or more ecosystems, such as a first ecosystem 512, a second ecosystem 514, and a third ecosystem 516. Although three ecosystems are shown in FIG. 5, in other implementations, user device 410 may include fewer than three ecosystems or more than three ecosystems.

In some implementations, first ecosystem 512 may include a cooperative ecosystem, second ecosystem 514 may include a semi-cooperative ecosystem, and third ecosystem 516 may include a non-cooperative ecosystem. The cooperative ecosystem may be associated with an explicit interaction or event, such as an interaction or event associated with a user of user device 410 and identified by an application. An example of the explicit interaction or event may include or correspond to an indication from an application that the user and/or one or more other user are active or present in or during an application. The semi-cooperative ecosystem may be associated with a semi-cooperative interaction or event, such as an interaction or event indicated based on presence data (e.g., rich presence data) associated with an application. The semi-cooperative interaction or event may include or correspond to the user starting or joining an application session, the user stopping or leaving an application session, the user unlocking an achievement, the user being at an application location for at least a time period, or a combination thereof. The non-cooperative ecosystem may be associated with a non-cooperative interaction or event, such as an interaction or event indicated based on non-ecosystem data. The non-cooperative interaction or event may include or correspond to a location (e.g., a physical location) of the user, social media information or data associated with the user, or a combination thereof.

Each of the one or more ecosystems may be configured to generate data associated with an interaction or event identified or determined by the ecosystem. For example, first ecosystem 512 may be configured to generate first data 522, second ecosystem 514 may be configured to generate second data 524, and third ecosystem 516 may be configured to generate third data 526. User device 410 may send data 522, 524, or 526 to server 450. For example, data 522, 524, or 526 may be sent to server 450 as telemetry data, such as first telemetry data 480.

Server 450 may receive data 522, 524, or 526 from user device 410 and store data 522, 524, or 526 at telemetry data 462. It is noted that telemetry data 462 may include data from one or more other user devices, such as second user device 430. For example, the data from one or more other user device may include or correspond to second telemetry data 482. In some implementations, data 522, 524, or 526 from user device 410, and/or the data from the one or more other user devices, may be provided to telemetry data 462 (e.g., memory 454), to analyzer 456, or a combination thereof.

Analyzer 456 may receive or access data from telemetry data 462. In some implementations, analyzer 456 may receive or access the data that is associated with an application session, such as a user session associated with user device 410. Additionally, or alternatively, analyzer 456 may access or receive data from session from session data 466. The data from session data 466 may include or correspond to one or more user sessions associated with user device 410. In some implementations, analyzer 456 may access or receive, from session data 466, user session data associated with one or more other user devices other than user device 410.

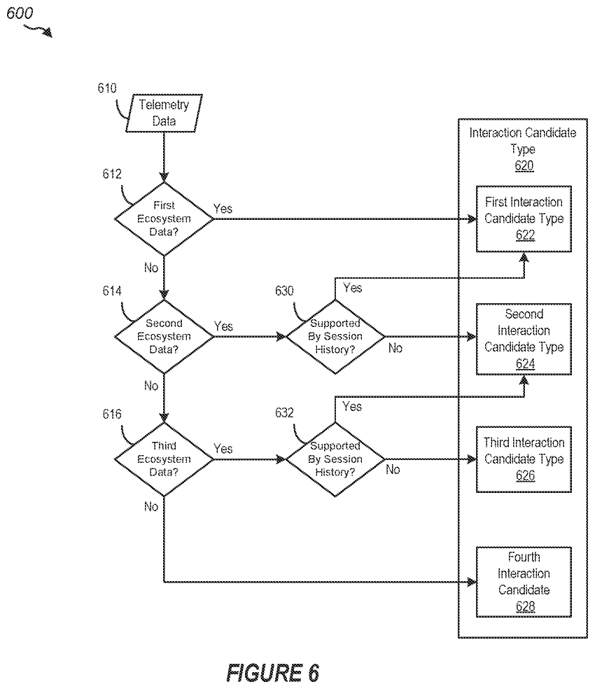

Analyzer 456 may process, the data (e.g., 522, 524, or 526) from telemetry data 462, data from session data 466, or a combination there of, to identify one or more candidate interactions, such as a representative candidate interaction 529. An example of a process performed by analyzer 456 is described herein at least with reference to FIG. 6. Candidate interaction 529 may include an interaction type, an interaction level (e.g., an interaction confidence value), or a combination thereof. In some implementations, each of the one or more candidate interactions may be associated with a set of one or more interactions between the user of user device 410 and another user. In some implementations, each of the one or candidate interactions may be associated with a user session, such as a user session associated with the user of user device 410.

First device 410 may receive candidate interaction 529 from analyzer 456. First device 410 may determine, at 530, a confidence level of candidate interaction 529. For example, first device 410 may determine the confidence level using processor 412. The confidence level may be determined or selected from multiple confidence levels, such as a first level, a second level, a third level, and a fourth level. In some implementations, the first level may be a high level, the second level may be a medium level, the third level may be a low level, and the fourth level may be a null level or a no confidence level. Although described as the multiple confidence levels having four levels, in other implementations, the multiple levels may include fewer than four levels or more than four levels.

Based on a determination, at 530, that candidate interaction 529 is the first level, user device 410 may classify candidate interaction 529 as a first interaction type 540. Based on a determination, at 530, that that candidate interaction 529 is the second level, user device 410 may issue a prompt to the user of user device 410. To illustrate, the prompt may request the user to input or verify whether or not another user associated with candidate interaction 529 is or was participating in the application session during the user session.

User device 532 may determine a response to the prompt at 532. Based on a determination, at 532, that the response confirms that another user is or was participating in the application session during the user session, candidate interaction 529 may classify candidate interaction 529 as a first interaction type 540. Alternatively, based on a determination, at 532, no response is received, candidate interaction 529 may classify candidate interaction 529 as a second interaction type 542. Alternatively, based on a determination, at 532, that the response indicates that another user is or was participating in the application session during the user session, candidate interaction 529 may classify candidate interaction 529 as no interaction 546.

Based on a determination, at 530, that candidate interaction 529 is the third level, user device 410 may classify candidate interaction 529 as a third interaction type 544. Alternatively, based a determination, at 530, that candidate interaction 529 is the fourth level, user device 410 may classify candidate interaction 529 as no interaction 546.

In some implementations, first interaction type 540 may include or correspond to a determined interaction between the user of user device 410 and the other user during the user session. The second interaction type 542 may include or correspond to a determination that an interaction between the user of user device 410 and the other user is likely, such as more likely than an interaction associated with the third interaction type 544. The third interaction type 544 may include or correspond to a determination that an interaction between the user of user device 410 and the other user is likely, such as less likely than an interaction associated with the second interaction type 542. Additionally, or alternatively, first interaction type 540 may indicate a high probability of an interaction, second interaction type 542 may indicate a medium probably of an interaction, and third interaction type 544 may indicate a low probably of an interaction. In some implementations, first interaction type 540, second interaction type 542, third interaction type 544, no interaction 546, or a combination thereof, may include or correspond to interaction type 486.

Although a prompt is described herein with reference to candidate interaction 529 being determined to be the second level, in other implementations, the prompt may be provided for each determined level. Alternatively, the prompt may be provided for one or more levels of the multiple levels, but not for all levels.

User device 410 may provide data that includes an indication of a determined interaction type, such as first interaction type 540, second interaction type 543, or third interaction type 544. The indication may be stored at session data 466 as part of user session data associated with the user session of the user of user device 410. In some implementations, the indication may indicate the interaction type, the other user, a user session ID of a user session associated with the other user, or a combination thereof.

FIG. 6 is a flow diagram of an example of a method 600 of recognition of user interaction associated with a user session according to one or more aspects of the present disclosure. Method 600 may be performed by a component, a device, or a system, such as server 450, processor 452, or telemetry analyzer 456.

Method 600 includes receiving telemetry data 610 and determining whether telemetry data 610 includes first ecosystem data, at 602. Telemetry data 610 may include or correspond to first telemetry data 480, second telemetry data 482, at least a portion of telemetry data 462, or a combination thereof. In some implementations, telemetry data 620 includes or corresponds to telemetry data associated with a user of first user device 410. First ecosystem data may include or correspond to first data 522 or other data from first ecosystem 512.

Based on a determination that telemetry data 610 includes the first ecosystem data, method 600 determines an interaction candidate type 620 associated with the telemetry data as a first interaction candidate type 622. In some implementations, the interaction candidate type 620 includes or corresponds to candidate type 468, interaction candidate type 484, candidate interaction 529, or a combination thereof. In some implementations, first interaction candidate type 622 may include or correspond to first level, such as a high confidence of an interaction or event. Alternatively, based on a determination that telemetry data 610 does not include the first ecosystem data, method 600 advances to 614.

At 614, method 600 determines whether telemetry data 610 includes second ecosystem data. Second ecosystem data may include or correspond to second data 524 or other data from second ecosystem 514. Based on a determination that telemetry data 610 does not include the second ecosystem data, method 600 advances to 616. Alternatively, based on a determination that telemetry data 610 includes the second ecosystem data, method 600 advances to 630.

At 630, method 600 determines whether an interaction or event based on telemetry data 610 is supported by session history data associated with the user of first user device 410. For example, the session history data may include or correspond to session data 466, such as data associated with one or more user sessions of a user of first user device 410. The interaction or event based on telemetry data 610 may be determined to be supported by the session history data based on one or more users session that indicate a first interaction type (e.g., 540) with another user, one or more user sessions that indicate a second interaction type (e.g., 542) with another user, one or more user sessions that indicate a third interaction type (e.g., 544) with another user, or a combination thereof. In some implementations, a number of previous user session, such as a number (e.g., 10 or 100) of most recent user session or user sessions during a time period (e.g., the past month), may be considered.

In some implementations, at 630, one or more user session that indicate the first interaction type (e.g., 540) with another user (out of a number of previous user sessions) may be compared to a first threshold. The interaction or event based on telemetry data 610 may be determined to be supported by the session history data if the one or more user sessions satisfies (e.g., is greater than or equal to) the first threshold. Additionally, or alternatively, at 630, one or more user session that indicate the second interaction type (e.g., 542) with another user (out of a number of previous user sessions) may be compared to a second threshold. The interaction or event based on telemetry data 610 may be determined to be supported by the session history data if the one or more user sessions satisfies (e.g., is greater than or equal to) the second threshold. Additionally, or alternatively, at 630, one or more user session that indicate the third interaction type (e.g., 546) with another user (out of a number of previous user sessions) may be compared to a third threshold. The interaction or event based on telemetry data 610 may be determined to be supported by the session history data if the one or more user sessions satisfies (e.g., is greater than or equal to) the third threshold.

Based on a determination that the interaction or event based on telemetry data 610 is supported by the session history data, method 600 determines interaction candidate type 620 associated with the telemetry data as first interaction candidate type 622. Alternatively, based on a determination that the interaction or event based on telemetry data 610 is not supported by the session history data, method 600 determines interaction candidate type 620 associated with the telemetry data as a second interaction candidate type 624. In some implementations, second interaction candidate type 624 may include or correspond to second level, such as a medium confidence of an interaction or event.

Method 600 includes determining whether telemetry data 610 includes third ecosystem data, at 616. Third ecosystem data may include or correspond to third data 526 or other data from third ecosystem 516. Based on a determination that telemetry data 610 does not include the third ecosystem data, method 600 determines interaction candidate type 620 associated with the telemetry data as a fourth interaction candidate type 628. In some implementations, fourth interaction candidate type 628 may include or correspond to fourth level, such as a no confidence of an interaction or event. Alternatively, based on a determination that telemetry data 610 includes the third ecosystem data, method 600 advances to 632.

At 632, method 600 determines whether an interaction or event based on telemetry data 610 is supported by the session history data associated with the user of first user device 410. The determination at 632 may be similar to or that same as the determination at 630. For example, the session history data may include or correspond to session data 466, such as data associated with one or more user sessions of a user of first user device 410. The interaction or event based on telemetry data 610 may be determined to be supported by the session history data based on one or more user session that indicate the first interaction type (e.g., 540) with another user, one or more user sessions that indicate the second interaction type (e.g., 542) with another user, one or more user sessions that indicate the third interaction type (e.g., 544) with another user, or a combination thereof. In some implementations, a number of previous user session, such as a number (e.g., 10 or 100) of most recent user session or user sessions during a time period (e.g., the past month), may be considered. The number of previous user sessions considered at 632 may be the same as or different than the number of previous user session considered at 630.

In some implementations, at 632, one or more user session that indicate the first interaction type (e.g., 540) with another user (out of a number of previous user sessions) may be compared to a first threshold. The interaction or event based on telemetry data 610 may be determined to be supported by the session history data if the one or more user sessions satisfies (e.g., is greater than or equal to) the first threshold. The first threshold at 632 may be the same as or different than the first threshold at 630. Additionally, or alternatively, at 632, one or more user session that indicate the second interaction type (e.g., 542) with another user (out of a number of previous user sessions) may be compared to a second threshold. The interaction or event based on telemetry data 610 may be determined to be supported by the session history data if the one or more user sessions satisfies (e.g., is greater than or equal to) the second threshold. The second threshold at 632 may be the same as or different than the second threshold at 630. Additionally, or alternatively, at 632, one or more user session that indicate the third interaction type (e.g., 546) with another user (out of a number of previous user sessions) may be compared to a third threshold. The interaction or event based on telemetry data 610 may be determined to be supported by the session history data if the one or more user sessions satisfies (e.g., is greater than or equal to) the third threshold. The third threshold at 632 may be the same as or different than the third threshold at 630.

Based on a determination that the interaction or event based on telemetry data 610 is supported by the session history data (at 632), method 600 determines interaction candidate type 620 associated with the telemetry data as second interaction candidate type 624. Alternatively, based on a determination that the interaction or event based on telemetry data 610 is not supported by the session history data (at 632), method 600 determines interaction candidate type 620 associated with the telemetry data as a third interaction candidate type 626. In some implementations, third interaction candidate type 626 may include or correspond to third level, such as a low confidence of an interaction or event.

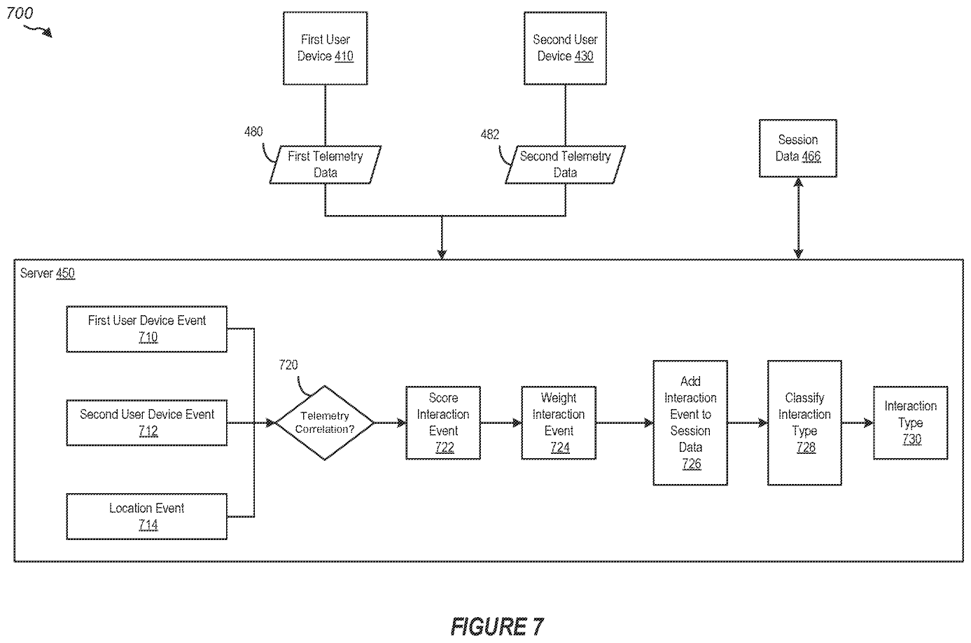

FIG. 7 an example of a system 700 for recognition of user interaction associated with a user session according to one or more aspects of the present disclosure. System 700 may include or correspond to system 100, 400, or 500. System 700 includes first user device 410, second user device 430, and server 450. First user device 410, second user device 430, and server 450 may be coupled via a network, such as network 402.

First user device 410 may be configured to generate first telemetry data 480 associated with an application session. In some implementations, first telemetry data 480 associated with the application session may correspond to a first user session of a first user of first user device 410. To illustrate, the first user session may include or correspond to a first time when the first user starts or joins the application session, a second time when the first user ends or leaves the application session, or a combination thereof. In some implementations, the first telemetry data 480 includes an indication of the first time, the second time, or a combination thereof.

Second user device 430 may be configured to generate second telemetry data 482 associated with the application session or another application session. In some implementations, second telemetry data 482 associated with the application session (or the other application session) may correspond to a second user session of a second user of second user device 430. To illustrate, the second user session may include or correspond to a third time when the second user starts or joins the application session (or the other application session), a fourth time when the second user ends or leaves the application session (or the other application session), or a combination thereof. In some implementations, the second telemetry data 482 includes an indication of the third time, the fourth time, or a combination thereof.

Server 450 may receive first telemetry data 480, second telemetry data 482, or a combination thereof. In some implementations, first user device 410 transmits first telemetry data 480 to session data 466 to generate a record of the first user session, second user device 430 transmits second telemetry data 482 to session data 466 to generate a record of the second user session, or a combination thereof. Additionally, in some implementations, first user device 410 transmits first telemetry data 480 to server 450, second user device 430 transmits second telemetry data 482 to server 450, or a combination thereof.

Server 450 may determine one or more first user device events 710 based on first telemetry data 480. Additionally, or alternatively, server may determine one or more second user device events 712 based on second telemetry data 482. In some implementations, server 450 may determine one or more location events, such as a location or change of location of the first user, the second user, or a combination thereof. To illustrate, in some implementations, first telemetry data 480 may indicate a location of first user device 410 or a location associated with the first user, second telemetry data 482 may indicate a location of second user device 430 or a location associated with the second user, or a combination thereof.

Server 450 may identify a potential correlation of received telemetry data based on the one or more first user device events 710, the one or more second user device events 712, the one or more location events 714, or a combination thereof. For example, server 450 may identify one or more of the events 710, 712, or 714 (e.g., one or more potential interaction events) that indicate that the first user and the second user have an interaction. In some implementations, an interaction may include each of the first user session and the second user session corresponding to the same application session, and at least a portion of the first user session and at least a portion of the second user session overlapping in time (e.g., occurring concurrently).

Based on an identified potential interaction event, server 450 may score, classify, or categorize the interaction event at 722 and may apply or designate a weight to the interaction event at 724. In some implementations, server 450 may classify, at 722, the interaction event from a set of interaction event classifications, such as user label, cooperative, nexus party, semi-cooperative, non-cooperative, or squad goal, as illustrative, non-limiting examples. Additionally, or alternatively, server 450 may designate a weight that is a static weight based on classification, may apply a dynamic weight based on session history data (e.g., session data 466), or a combination thereof. In some implementations, the static weight may be a predetermined weight that is always applied to a classification, that is initially applied to a classification for a user, or is applied based on a condition, such as the classification not being identified in a previous number of user sessions. In some implementations, the dynamic weight may be determined based on the session history data and/or a feedback mechanism, such as intelligent learning over time. To illustrate, server 450 may dynamically determine a weight based on session history data as part of a reinforcement mechanism of an algorithm or model. For example, the model may include or correspond to model 464. The reinforcement mechanism may be configured to improve an indication or determination of interaction between two users in an application session.

Server 450 may add the interaction event to session data (e.g., 466), at 726. Adding the interaction event may include adding an ID of the interaction event, the score/classification of the interaction event, the weight of the interaction event, or a combination thereof. Additionally, or alternatively, server 450 may classify an interaction type, at 728. For example, server 450 may classify the interaction type based one or more interaction events associated with the first user and the second user. In some implementations, the classification of the interaction type may be determined based on a sum of weights of the one or more interaction events, based on method 600, or a combination thereof. In some implementations, the classification of the interaction type, at 728, may include or correspond to candidate type 468, interaction candidate type 484, candidate interaction 529, or interaction candidate type 620.

Additionally, or alternatively, sever 450 may determine an interaction type 730. The interaction type 730 may include or correspond to interaction type 486 or one of first interaction type 540, second interaction type 542, third interaction type 544, or no interaction 546. In some implementations, interaction type 730 (or an indication thereof) may be stored at session data 466 as part of or in association with the first user session or the second user session. Additionally, or alternatively, interaction type 730 may include or indicate a likelihood of an interaction, a type of the interaction, or a combination thereof.

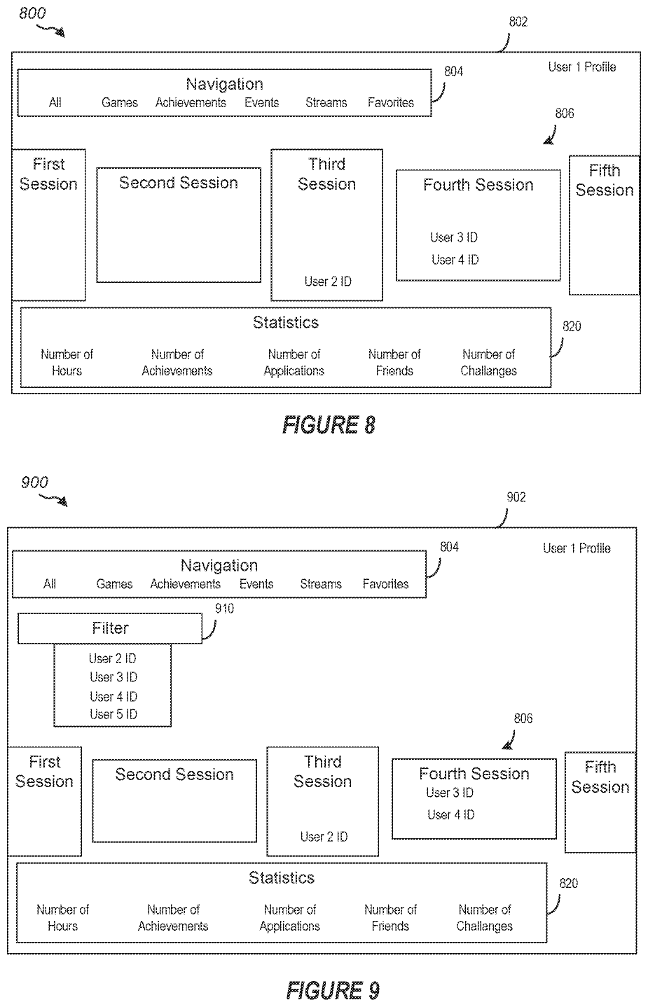

FIG. 8 illustrates a diagram of an example of an interface 800 according to one or more aspects of the present disclosure. Interface 800 includes a dashboard panel 802 associated with a first user (User 1) profile. For example, the first user may include or correspond to a user of first user device 410. Dashboard panel 802 includes a navigation bar 804, a timeline 806, and a statistics bar 820. Navigation bar 804 includes selectable options to navigate or change a presentation of interface 800 (e.g., dashboard panel 802).

Timeline 806 indicates past user sessions. In some implementations, the past user session may provide information associated with the user session, such as a title of an application session, a summary of the user session, a achievement gained during the user session, or a combination thereof, as illustrative, non-limiting examples. As shown the past user sessions include a first session, a second session, a third session, a fourth session, and a fifth session. The first through fifth session are arranged in time order with first session being the oldest and the fifth session being the newest. In some implementations, additional user sessions of timeline 806 may be identified my scrolling (e.g., left or right) on timeline 806.

As shown, one or more user sessions may identify another user that the first user interacted with or that was present during the user session. For example, the third session indicates that a second user (i.e., User 2) was present during the third session or interacted with the first user during the third session. As another example, the fourth session indicates that each of a third user (i.e., User 3) and a fourth user (i.e., User 4) were present during the fourth session or interacted with the first user during the fourth session. In some implementations, a user session that indicates another user may include information about an interaction between the first user and the other user, such as an amount (e.g., duration) of interaction, a percentage of interaction of the a total time of the session, a total number of session that include an interaction with the other user, a number of applications that include an interaction with the other user, a result of an interaction with the other user, or a combination thereof, as illustrative, non-limiting examples.

In some implementations, another user may be identified based on session data 466 associated with the first user. In some implementations, another user may be indicated with a presented user session if corresponding session data (e.g., 466) indicates a first interaction type 540 associated with the first user and the other user during the user session.

FIG. 9 illustrates a diagram of another example of an interface 900 according to one or more aspects of the present disclosure. Interface 900 includes a dashboard panel 902 associated with a first user (User 1) profile. Dashboard panel 902 may include or correspond to dashboard panel 802.

As shown, dashboard panel 902 includes a filter option 910, such as a drop down menu filter option. In some implementations, filter option 910 may be configured to receive text to perform a filtered search and a drop down menu of possible filter matches may be presented. Additionally, or alternatively, filter option 910 may be configured to filter information presented via dashboard panel 902 based on an application, a user session, a date or time, statistics, or a combination thereof, as illustrative non-limiting examples. To illustrate, the first user may be able to filter statistics bar 820 to present statistics associated with one or more interactions between the first user and the second user (i.e., User 2). For example, statistics bar 820 may indicate an amount (e.g., duration as total time, longest amount, shortest amount, average amount) of interaction, a type of interaction (e.g., teammate, opponent, gaming, metaverse, social, romantic, commercial, etc.), a percentage of interaction of the a total time of the session, a total number of sessions that include an interaction with the other user, a number of applications that include an interaction with the other user, a result (e.g., an achievement) of or associated with an interaction with the other user, a number of mutual friends, or a combination thereof, as illustrative, non-limiting examples.

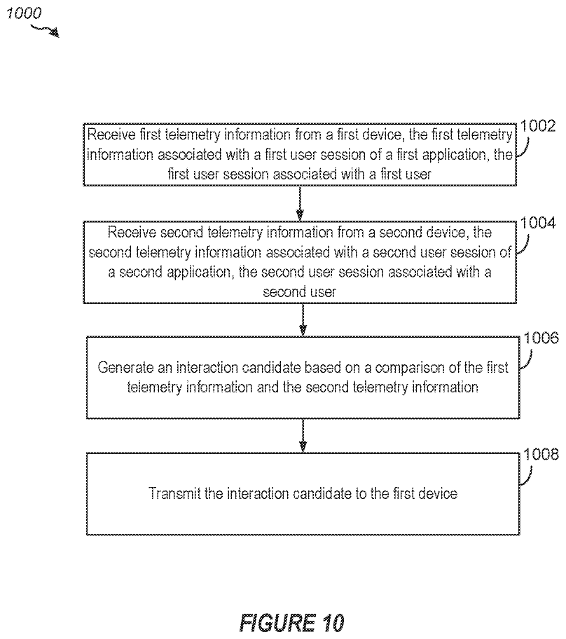

Referring to FIG. 10, a method 1000 of recognition of user interaction associated with a user session according to one or more aspects of the present disclosure is shown. Method 1000 may be performed at or by a server, such as server 450, or a component of or coupled to the server.

Method 1000 includes receiving first telemetry information from a first device, the first telemetry information associated with a first user session of a first application, the first user session associated with a first user, at 1002. The first device and the first telemetry data may include or correspond to first user device 410 and first telemetry data 480, respectively. Additionally, or alternatively, the first telemetry data may include or correspond to first data, 522, second data 524, third data 526, telemetry data 610, or a combination thereof.

Method 1000 further includes receiving second telemetry information from a second device, the second telemetry information associated with a second user session of a second application, the second user session associated with a second user, at 1004. The second device and the second telemetry data may include or correspond to second user device 430 and second telemetry data 482, respectively. Additionally, or alternatively, the second telemetry data may include or correspond to first data, 522, second data 524, third data 526, telemetry data 610, or a combination thereof.

Method 1000 also includes generating an interaction candidate based on a comparison of the first telemetry information and the second telemetry information, at 1006. The interaction candidate may include or correspond to candidate type 468, interaction candidate type 484, candidate interaction 529, one of candidate type 620, a classified interaction type (e.g., 728), or a combination thereof.

Method 1000 includes transmitting the interaction candidate to the first device, at 1008. For example, a server may transmit the interaction candidate, such as candidate type 468, interaction candidate type 484, candidate interaction 529, one of candidate type 620, a classified interaction type (e.g., 728), or a combination thereof.

In some implementations, method 1000 may include after transmitting the interaction candidate, receiving, from the first device, an interaction type determined based on the interaction candidate. For example, the interaction type may include or correspond to the interaction type 486, first interaction type 540, second interaction type 542, third interaction type 544, interaction type 730, or a combination thereof. The method 1000 may also include storing an indication of the interaction candidate, the interaction type, or both, in association with first user session information associated with the first user session. For example, the indication may be stored as session data 466. In some implementations, the first application and the second application are the same application.

In some implementations, method 1000 may include receiving, based on the first telemetry information, session information associated with one or more user sessions that occurred prior to the first user session. The one or more user sessions may be associated with the first user. For example, the one or more session may include or correspond to session data 466. In some implementations, the interaction candidate is further generated based on at least one user session of the one or more user sessions.

In some implementations, method 1000 may include determining, based on the first telemetry information, an interaction event. Additionally, or alternatively, method 1000 may include determining a classification associated with the interaction event. In some implementations, the classification is selected from multiple classifications. Method 1000 may also include determining a value associated with the interaction event. In some such implementations, the interaction candidate is further generated based on one or more interaction events including the interaction event.

In some implementations, method 1000 may include accessing a model associated with the first user, the second user, or a combination thereof. For example, the model may include or correspond to model 464. Method 100 may also include determining the weight value associated with the interaction event based on the model. In some implementations, the weight value is a static value that corresponds to the classification. In some other implementations, method 1000 may include receiving session information associated with one or more user sessions that occurred prior to the first user session. The one or more user sessions may be associated with the first user. Method 100 may further include updating a prior model associated with the first user, the second user, or a combination thereof, based on the session information, to generate the model.

In some implementations, method 1000 may include initiating at prompt at the first user device. In some implementations, the prompt may request input whether the first user interacted with the second user during the first use session. For example, the prompt may include or correspond to a prompt response (e.g., 532). In some implementations, method 1000 includes receiving a response to the prompt from the first user device.

In some implementations, method 1000 may include receiving session information associated with one or more user sessions associated with the first user. For example, the session information may include or correspond to session data 466. In some implementations, each of the one or more user sessions includes a determined interaction between the first user and the second user during the user session. Method 1000 may also include generating an output based on at least one interaction between the first user and the second user indicated by the one or more user sessions. The output may include or correspond to output data 488. Method 1000 may further include transmitting the output to the first user device.

Method 1000 may be embedded in a computer-readable medium as computer program code comprising instructions that cause a processor to perform one or more operations of method 1000. In some implementations, the processor may be part of an information handling system including a first network adaptor configured to transmit data over a first network connection; and a processor coupled to the first network adaptor, and a memory storing processor-executable instructions. In some implementations, method 1000 may be performed by one or more processors, such as a processor of a user input device, a processor of an information handling system, or a combination thereof.

It is noted that one or more blocks (or operations) described with reference to FIG. 6 or 10 may be combined with one or more blocks (or operations) described with reference to another of the figures. For example, one or more blocks (or operations) of FIG. 6 may be combined with one or more blocks (or operations) of FIG. 10. As another example, one or more blocks associated with FIG. 6 or 10 may be combined with one or more blocks (or operations) associated with FIG. 1-5 or 7-9. For example, one or more blocks (or operations) described with reference to FIG. 10 may be combined with one or more operations described with reference to system 400 of FIG. 4, system 500 of FIG. 5, or system 7 of FIG. 7.

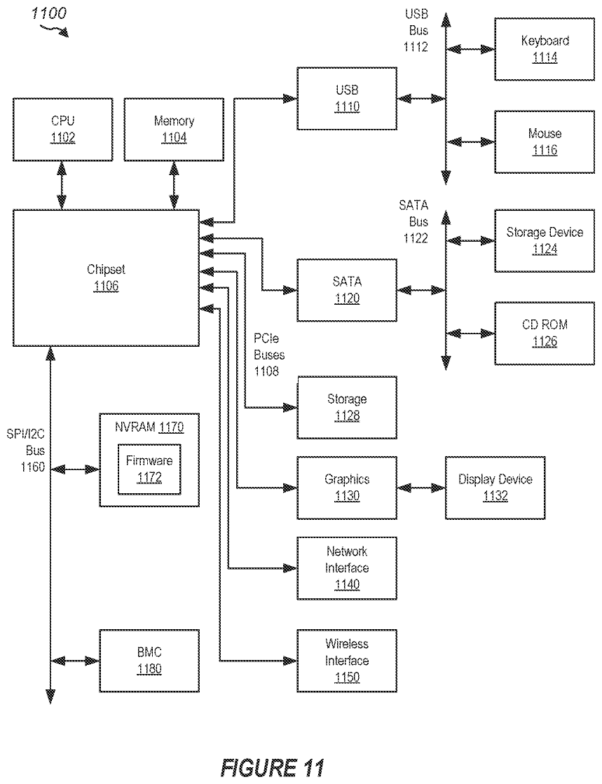

FIG. 11 illustrates an example information handling system 1100. Information handling system 1100 may include a processor 1102 (e.g., a central processing unit (CPU)), a memory (e.g., a dynamic random-access memory (DRAM)) 1104, and a chipset 1106. In some embodiments, processor 1102, memory 1104, and chipset 1106 may be included on a motherboard (also referred to as a mainboard), which is a printed circuit board (PCB) with embedded conductors organized as transmission lines between processor 1102, memory 1104, chipset 1106, and/or other components of the information handling system 1100. The components may be coupled to the motherboard through packaging connections such as a pin grid array (PGA), ball grid array (BGA), land grid array (LGA), surface-mount technology, and/or through-hole technology. In some embodiments, processor 1102, memory 1104, chipset 1106, and/or other components may be organized as a System on Chip (SoC).

Processor 1102 may execute program code by accessing instructions loaded into memory 1104 from a storage device, executing the instructions to operate on data also loaded into memory 1104 from a storage device, and generate output data that is stored back into memory 1104 or sent to another component. Processor 1102 may include processing cores capable of implementing any of a variety of instruction set architectures (ISAs), such as the x86, POWERPC®, ARM®, SPARC®, or MIPS® ISAs, or any other suitable ISA. In multi-processor systems, each of processors 1102 may commonly, but not necessarily, implement the same ISA. In some implementations, multiple processors may each have different configurations such as when multiple processors are present in a big-little hybrid configuration with some high-performance processing cores and some high-efficiency processing cores. Chipset 1106 may facilitate the transfer of data between processor 1102, memory 1104, and other components. In some implementations, chipset 1106 may include two or more integrated circuits (ICs), such as a northbridge controller coupled to processor 1102, memory 1104, and a southbridge controller, with the southbridge controller coupled to the other components such as USB 1110, SATA 1120, or PCIe buses 1108. Chipset 1106 may couple to other components through one or more PCIe buses 1108.

Some components may be coupled to one bus line of PCIe buses 1108, whereas some components may be coupled to more than one bus line of PCIe buses 1108. One example component is a universal serial bus (USB) controller 1110, which interfaces the chipset 1106 to a USB bus 1112. USB bus 1112 may couple input/output components such as a keyboard 1114 and a mouse 1116, but also other components such as USB flash drives, or another information handling system. Another example component is a SATA bus controller 1120, which couples the chipset 1106 to a SATA bus 1122. SATA bus 1122 may facilitate efficient transfer of data between chipset 1106 and components coupled to the chipset 1106 and a storage device 1124 (e.g., a hard disk drive (HDD) or solid-state disk drive (SDD)) and/or a compact disc read-only memory (CD-ROM) 1126. PCIe bus 1108 may also couple chipset 1106 directly to a storage device 1128 (e.g., a solid-state disk drive (SDD)). A further example of an example component is a graphics device 1130 (e.g., a graphics processing unit (GPU)) for generating output to a display device 1132, a network interface controller (NIC) 1140, and/or a wireless interface 1150 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces). In some implementations, chipset 1106 may be directly connected to an individual end point via a PCIe root port within the chipset and a point-to-point topology as shown in FIG. 11.

Chipset 1106 may also be coupled to a serial peripheral interface (SPI) and/or Inter-Integrated Circuit (I2C) bus 1160, which couples chipset 1106 to system management components. For example, a non-volatile random-access memory (NVRAM) 1170 for storing firmware 1172 may be coupled to bus 1160. As another example, a controller, such as a baseboard management controller (BMC) 1180, may be coupled to the chipset 1106 through the bus 1160. BMC 1180 may be referred to as a service processor or embedded controller (EC). Capabilities and functions provided by BMC 1180 may vary considerably based on the type of information handling system. For example, the term baseboard management system may be used to describe an embedded processor included at a server, while an embedded controller may be found in a consumer-level device. As disclosed herein, BMC 1180 represents a processing device different from processor 1102, which provides various management functions for information handling system 1100. For example, an embedded controller may be responsible for power management, cooling management, and the like. An embedded controller included at a data storage system may be referred to as a storage enclosure processor or a chassis processor.

Information handling system 1100 may include additional processors that are configured to provide localized or specific control functions, such as a battery management controller. Bus 1160 can include one or more busses, including a Serial Peripheral Interface (SPI) bus, an Inter-Integrated Circuit (I2C) bus, a system management bus (SMBUS), a power management bus (PMBUS), or the like. BMC 1180 may be configured to provide out-of-band access to devices at information handling system 1100. Out-of-band access in the context of the bus 1160 may refer to operations performed prior to execution of firmware 1172 by processor 1102 to initialize operation of information handling system 1100.

Firmware 1172 may include instructions executable by processor 1102 to initialize and test the hardware components of information handling system 1100. For example, the instructions may cause the processor 1102 to execute a power-on self-test (POST). The instructions may further cause the processor 1102 to load a boot loader or an operating system (OS) from a mass storage device. Firmware 1172 additionally may provide an abstraction layer for the hardware, such as a consistent way for application programs and operating systems to interact with the keyboard, display, and other input/output devices. When power is first applied to information handling system 1100, the system may begin a sequence of initialization procedures, such as a boot procedure or a secure boot procedure. During the initialization sequence, also referred to as a boot sequence, components of information handling system 1100 may be configured and enabled for operation and device drivers may be installed. Device drivers may provide an interface through which other components of information handling system 1100 can communicate with a corresponding device. Firmware 1172 may include a basic input-output system (BIOS) and/or include a unified extensible firmware interface (UEFI). Firmware 1172 may also include one or more firmware modules of the information handling system. Additionally, configuration settings for Firmware 1172 and firmware of the information handling system 1100 may be stored in the NVRAM 1170. NVRAM 1170 may, for example, be a non-volatile firmware memory of information handling system 1100 and may store a firmware memory map namespace of information handling system 1100. NVRAM 1170 may further store one or more container-specific firmware memory map namespaces for one or more containers concurrently executed by the information handling system.

Information handling system 1100 may include additional components and additional busses, not shown for clarity. For example, information handling system 1100 may include multiple processor cores (either within processor 1102 or separately coupled to chipset 1106 or through the PCIe buses 1108), audio devices (such as may be coupled to chipset 1106 through one of the PCIe busses 1108), or the like. While a particular arrangement of bus technologies and interconnections is illustrated for the purpose of example, one of skill will appreciate that the techniques disclosed herein are applicable to other system architectures. Information handling system 1100 may include multiple processors and/or redundant bus controllers. In some implementations, one or more components may be integrated together in an integrated circuit (IC), which is circuitry built on a common substrate. For example, portions of chipset 1106 can be integrated within processor 1102. Additional components of information handling system 1100 may include one or more storage devices that may store machine-executable code, one or more communications ports for communicating with external devices, and various input and output (I/O) devices, such as a keyboard, a mouse, and a video display.

In some implementations, processor 1102 may include multiple processors, such as multiple processing cores for parallel processing by information handling system 1100. For example, information handling system 1100 may include a server comprising multiple processors for parallel processing. In some implementations, information handling system 1100 may support virtual machine (VM) operation, with multiple virtualized instances of one or more operating systems executed in parallel by information handling system 1100. For example, resources, such as processors or processing cores of the information handling system may be assigned to multiple containerized instances of one or more operating systems of information handling system 1100 executed in parallel. A container may, for example, be a virtual machine executed by information handling system 1100 for execution of an instance of an operating system by information handling system 1100. Thus, for example, multiple users may remotely connect to information handling system 1100, such as in a cloud computing configuration, to utilize resources of information handling system 1100, such as memory, processors, and other hardware, firmware, and software capabilities of information handling system 1100. Parallel execution of multiple containers by information handling system 1100 may allow information handling system 1100 to execute tasks for multiple users in parallel secure virtual environments.

The flow chart diagram of FIG. 6 or 10 is generally set forth as a logical flow chart diagram, as well as some operations described at least with reference to FIGS. 5 and 7. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one implementation or may relate to several implementations.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular examples of the process, machine, manufacture, composition of matter, means, methods and steps described in the specification. For example, although processors are described throughout the detailed description, aspects of the disclosure may be applied to the design of or implemented on different kinds of processors, such as graphics processing units (GPUs), central processing units (CPUs), and digital signal processors (DSPs). As another example, although processing of certain kinds of data may be described, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding examples described herein may be utilized. Accordingly, the appended claims are intended to include within their scope such processes, machines, manufacture, compositions of matter, means, methods, or steps.

1. A method comprising:
receiving first telemetry information from a first device, the first telemetry information associated with a first user session of a first application, the first user session associated with a first user;
receiving second telemetry information from a second device, the second telemetry information associated with a second user session of a second application, the second user session associated with a second user;
generating an interaction candidate based on a comparison of the first telemetry information and the second telemetry information; and
transmitting the interaction candidate to the first device.

2. The method of claim 1, further comprising:
after transmitting the interaction candidate, receiving, from the first device, an interaction type determined based on the interaction candidate; and
storing an indication of the interaction candidate, the interaction type, or both, in association with first user session information associated with the first user session,
wherein the first application and the second application are the same application.

3. The method of claim 1, further comprising:
receiving, based on the first telemetry information, session information associated with one or more user sessions that occurred prior to the first user session, the one or more user sessions associated with the first user,
wherein the interaction candidate is further generated based on at least one user session of the one or more user sessions.

4. The method of claim 1, further comprising:
determining, based on the first telemetry information, an interaction event;
determining a classification associated with the interaction event, the classification selected from multiple classifications; and
determining a value associated with the interaction event,
wherein the interaction candidate is further generated based on one or more interaction events including the interaction event.

5. The method of claim 4, further comprising:
accessing a model associated with the first user, the second user, or a combination thereof; and
determining the weight value associated with the interaction event based on the model.

6. The method of claim 5, further comprising receiving third telemetry data after transmitting the interaction candidate to the first device; and updating the model based on the third telemetry data.

7. The method of claim 5, further comprising:
receiving session information associated with one or more user sessions that occurred prior to the first user session, the one or more user sessions associated with the first user; and
updating a prior model associated with the first user, the second user, or a combination thereof, based on the session information, to generate the model.

8. The method of claim 1, further comprising:
initiating a prompt at the first user device, the prompt requesting input whether the first user interacted with the second user during the first use session; and
receiving a response to the prompt from the first user device,
wherein the interaction candidate is further generated based on the response.

9. The method of claim 1, further comprising:
receiving session information associated with one or more user sessions associated with the first user, wherein each of the one or more user sessions includes a determined interaction between the first user and the second user during the user session;
generating an output based on at least one interaction between the first user and the second user indicated by the one or more user sessions; and
transmitting the output to the first user device.

10. An information handling system, comprising:
at least one processor; and
a memory coupled with the at least one processor and storing processor-readable code that, when executed by the at least one processor, is configured to perform operations including:
generating first telemetry information associated with a first user session of a first application, the first user session associated with a first user;
transmitting the first telemetry information to a server;
receiving, from the server, an interaction candidate, the interaction candidate associated with a potential interaction between the first user of the first user session and a second user of a second user session associated with a second application; and
determining an interaction type determined based on the interaction candidate.

11. The apparatus of claim 10, wherein the operations further include:
after transmitting the interaction candidate, receiving, from the first device, an interaction type determined based on the interaction candidate; and
storing an indication of the interaction candidate, the interaction type, or both, in association with first user session information associated with the first user session,
wherein the first application and the second application are the same application.

12. The apparatus of claim 10, wherein the operations further include:
receiving, based on the first telemetry information, session information associated with one or more user sessions that occurred prior to the first user session, the one or more user sessions associated with the first user,
wherein the interaction candidate is further generated based on at least one user session of the one or more user sessions.

13. The apparatus of claim 10, wherein the operations further include:
determining, based on the first telemetry information, an interaction event;
determining a classification associated with the interaction event, the classification selected from multiple classifications; and
determining a value associated with the interaction event,
wherein the interaction candidate is further generated based on one or more interaction events including the interaction event.

14. The apparatus of claim 13, wherein the operations further include:
accessing a model associated with the first user, the second user, or a combination thereof; and
determining the weight value associated with the interaction event based on the model.

15. The apparatus of claim 14, wherein the operations further include receiving third telemetry data after transmitting the interaction candidate to the first device; and
updating the model based on the third telemetry data.

16. The apparatus of claim 10, wherein the operations further include:
initiating a prompt at the first user device, the prompt requesting input whether the first user interacted with the second user during the first use session; and
receiving a response to the prompt from the first user device,
wherein the interaction candidate is further generated based on the response.

17. A system, comprising:
a first device associated with a first user session of a first application, the first user session associated with a first user, the first user device configured to generate first telemetry information associated with the first user session;
a second device associated with a second user session of a second application, the second user session associated with a second user, the second user device configured to generate first telemetry information associated with the first user session; and
a server configured to:
receive the first telemetry information from the first device;
receive the second telemetry information from the second device; and
generate an interaction candidate based on a comparison of the first telemetry information and the second telemetry information; and
transmit the interaction candidate to the first device.

18. The system of claim 17, wherein the server is further configured to:
after transmission of the interaction candidate, receive, from the first device, an interaction type determined based on the interaction candidate; and
store an indication of the interaction candidate, the interaction type, or both, in association with first user session information associated with the first user session, and
wherein the first application and the second application are the same application.

19. The system of claim 17, wherein the server is further configured to:
receive third telemetry data after transmitting the interaction candidate to the first device; and
update the model based on the third telemetry data.

20. The system of claim 17, wherein the server is further configured to:
determine, based on the first telemetry information, an interaction event;
determine a classification associated with the interaction event, the classification selected from multiple classifications; and
determine a value associated with the interaction event, and
wherein the interaction candidate is further generated based on one or more interaction events including the interaction event.
